(19) United States
(12) Patent Application Publication
(10) Pub. No.: US 2016/0091185 A1
(43) Pub. Date: Mar. 31, 2016

(54) METHODS AND APPARATUS FOR LIGHTING AN AREA

(71) Applicant: Soderworld Enterprises, LLC, Willowbrook, IL (US)

(72) Inventor: Chad Soderholm, Willowbrook, IL (US)

(21) Appl. No.: 14/871,249

(22) Filed: Sep. 30, 2015

Related U.S. Application Data
(60) Provisional application No. 62/057,464, filed on Sep. 30, 2014.

(51) Int. Cl. F21V 21/14; F21L 4/08; F21V 21/34; F21V 21/096; F21V 21/092; F21L 4/02; F21V 21/08

(52) U.S. Cl. CPC F21V 21/145; F21L 4/02; F21L 4/08; F21V 21/0832; F21V 21/0965; F21V 21/0925; F21V 21/34; F21Y 2103/003

(57) ABSTRACT

An example light-weight, portable, and flexible light bank is disclosed. The example apparatus includes an array of flexible LED (light emitting diodes) strips affixed to a cloth, fabric or rag-like material of a various sizes and shapes with a hook and loop mounting system to attach to various suitable mounting accessories. The apparatus can be easily rolled up or folded like a rag for storage or transport. The lights feature waterproof and non-waterproof versions of various color temperatures, functions and brightness. The lights can be daisy-chained (linked) together to create a larger light source. The light system can be held, hung, and/or mounted to objects. Battery packs and solar panel battery charger can be stacked and mounted behind the light bank.

### RELATED CASES

This application claims priority to Provisional Application Ser. No. 62/057,464, filed on Sep. 30, 2014, having inventor Chad Soderholm, titled “METHODS AND APPARATUS FOR LIGHTING AN AREA”, and is incorporated herein by reference.

### BACKGROUND

Many different situations require professional illumination, such as photographic sets, movie sets, emergency situations, parties, etc. However, traditional high-end lighting can be expensive, heavy, difficult to construct and deconstruct, difficult to transport, fragile, and burdensome.

### SUMMARY

The system disclosed herein solves these problems, and others, using a plurality of high-intensity adjustable light emitting diodes (LEDs) mounted to a flexible surface. In this manner, and as described in detail below, an extremely lightweight, inexpensive, and portable lighting system is achieved. In some embodiments, the lighting system is essentially indestructible and/or waterproof.

### BRIEF DESCRIPTION OF THE FIGURES

FIG. 1 is a perspective view of an example light bank.

FIG. 2 is a front side view of an example light bank.

FIG. 3 is an expanded view of an example light bank.

FIG. 4 is a constructed view of an example light bank.

FIG. 5 is a backside view of an example light bank.

FIG. 6 illustrates an example light controller in a waterproof housing.

FIG. 7 illustrates an example light controller attached to a light bank.

FIG. 8 is an example fabric back cover.

FIG. 9 is an example fabric.

FIG. 10 illustrates an example light bank roll-up.

FIG. 11 is an example rolled light bank.

FIG. 12 illustrates a 360 degree torch mode with an example.

FIG. 13 illustrates an example flexible Velcro frame.

FIG. 14 illustrates an example frame system criss-cross.

FIG. 15 illustrates an example flexible mounting frame.

FIG. 16 illustrates an example light bank array.

FIG. 17 illustrates example D-ring accessories.

FIG. 18 illustrates example mounting accessories.

FIG. 19 illustrates an example elastic magnetic accessory.

FIG. 20 illustrates an example Velcro magnetic gel holder.

FIG. 21 illustrates example elastic Velcro straps.

FIG. 22 illustrates example adjustable Velcro straps.

FIG. 23 an example frame mount.

FIG. 24 an example suction mount.

FIG. 25 illustrates an example camera hot shoe mount.

FIG. 26 an example lighted camera mount.

FIG. 27 illustrates an example camera mount with a frame.

FIG. 28 illustrates an example camera mount with a bendable frame.

FIG. 29 is an example of a boom pole and light stand.

FIG. 30 is an example of a stand with an attachment.

FIG. 31 is an example of an umbrella light bank.

FIG. 32 is an example of a tent attachment with a cloth material for shelter.

FIG. 33 is an example of a power source.

FIG. 34 is an example of a roll-up battery pack.

FIG. 35 is an example view of a fabric cover lined with hook Velcro borders.

FIG. 36 illustrates an example of a power source and solar charger component.

### DETAILED DESCRIPTION

An example light-weight, portable, and flexible light bank is disclosed. The example apparatus includes an array of flexible LED (light emitting diodes) strips affixed to a cloth, fabric or rag-like material of a various sizes and shapes with a Velcroed (hook and loop) mounting system to attach to various suitable mounting accessories. The apparatus can be easily rolled up or folded like a rag for storage or transport. The lights feature waterproof and non-waterproof versions of various color temperatures, functions and brightness. The lights can be daisy-chained (linked) together to create a larger light source. The light system can be held, hung, and/or mounted to objects. Battery packs and solar panel battery charger can be stacked and mounted behind the light bank.

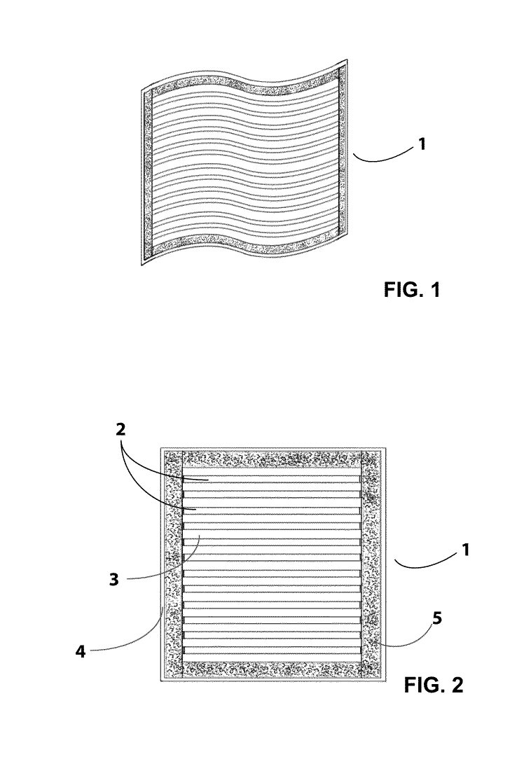

FIG. 1 is a perspective view of an example light bank 1 of various shapes and sizes consisting of an array of Flexible LED strips of various configurations, color temperatures and brightnesses mounted to fabric or other suitable flexible material to create a light source system, which can be mounted, held or hung via Velcro (hook and loop) mounted to fabric or any other suitable mounting apparatus.

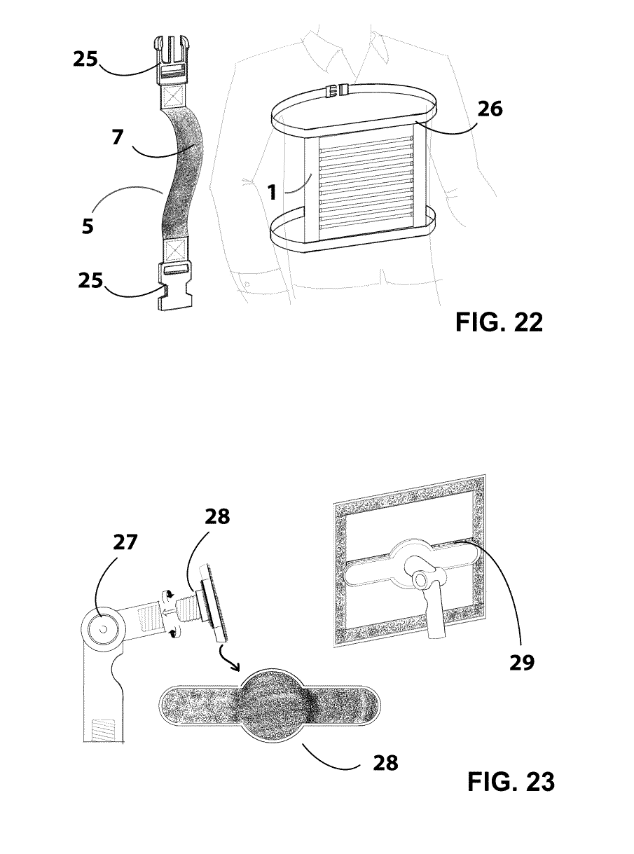

FIG. 2 is a front side view of an example light bank 1 consisting of an array of flexible LED light strips connected through an electrical circuit 2 attached to a flexible material 3 and in cased within an outer fabric shell 4 with Velcro border 5 to attach various accessories FIG. 13, FIG. 17, FIG. 19, FIG. 21 and FIG. 22.

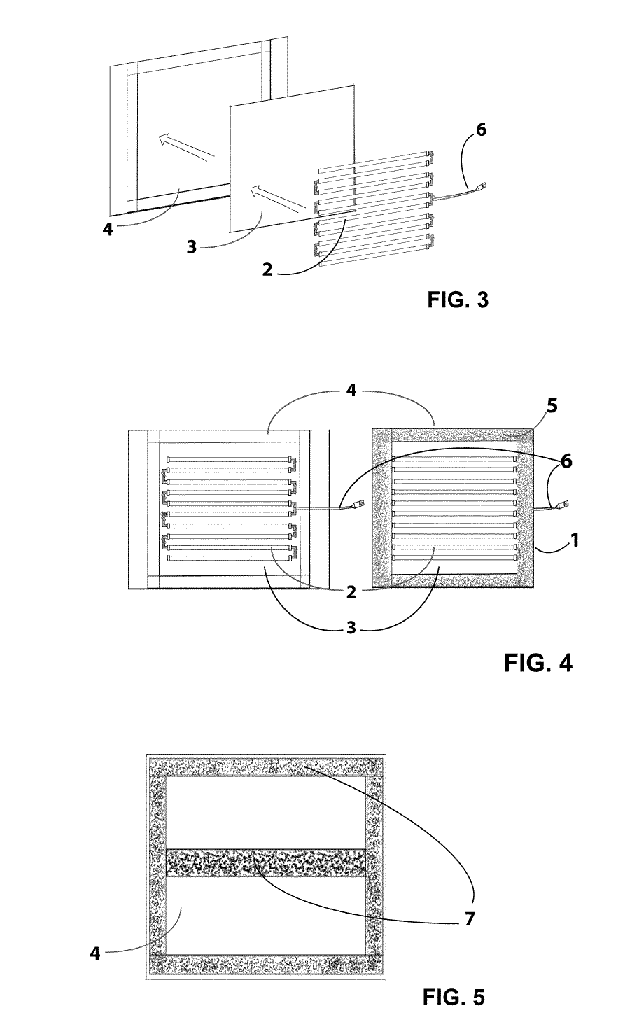

FIG. 3 is an expanded view of an example light bank 1 consisting of an array of flexible LED light strips 2 connected through an electrical circuit 6 adhered to an inner fabric material 3 combined with an outer fabric shell 4.

FIG. 4 is a constructed view of an example light bank 1 consisting of the outer fabric shell 4 combined with a series of flexible LED light strips 2 connected through an electrical circuit 6 attached to a flexible material 3 with hook Velcro borders 5.

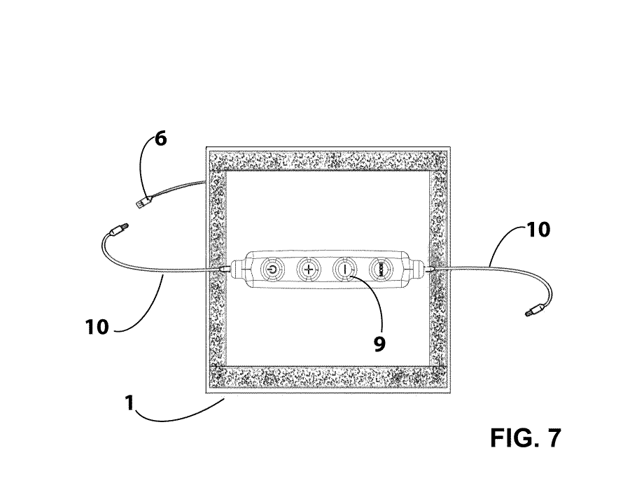

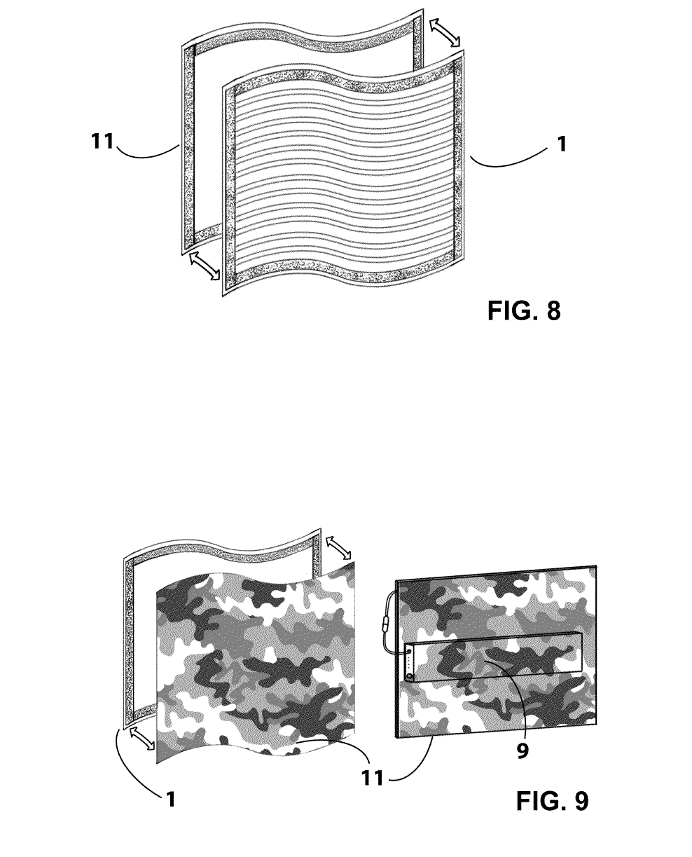

FIG. 5 is a backside view of an example light bank 1 consisting of the outer fabric shell 4 with loop Velcro borders 7 to attach various accessories FIG. 7, FIG. 8 and FIG. 9.

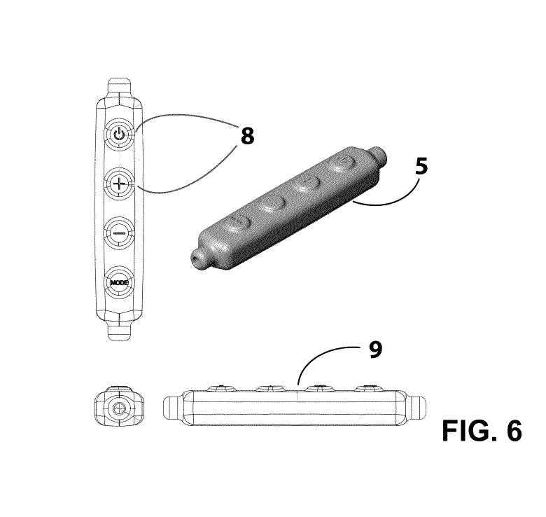

FIG. 6 illustrates an example light controller in a waterproof housing containing an integrated buttoned controller either hardwired or wireless for remote control of the LED light strips to change brightness, color temperature, color tint, strobe, flash, or blink in various patterns 8 hook velcroed backing 5 attached to a light bank FIG. 7.

FIG. 7 illustrates an example light controler 9 attached to a light bank 1, which are connected via a waterproof cable 10 into the series of flexible LED light strips connected through an electrical circuit 6 and or into a power outlet or the battery.

FIG. 8 is an example fabric back cover lined with hook Velcro borders 11 that attach to a light bank 1.

FIG. 9 is an example fabric cover lined with hook Velcro borders 11 attaches to a light bank 1 which covers the waterproof controller 9 and also acts as a carrying pocket for accessories.

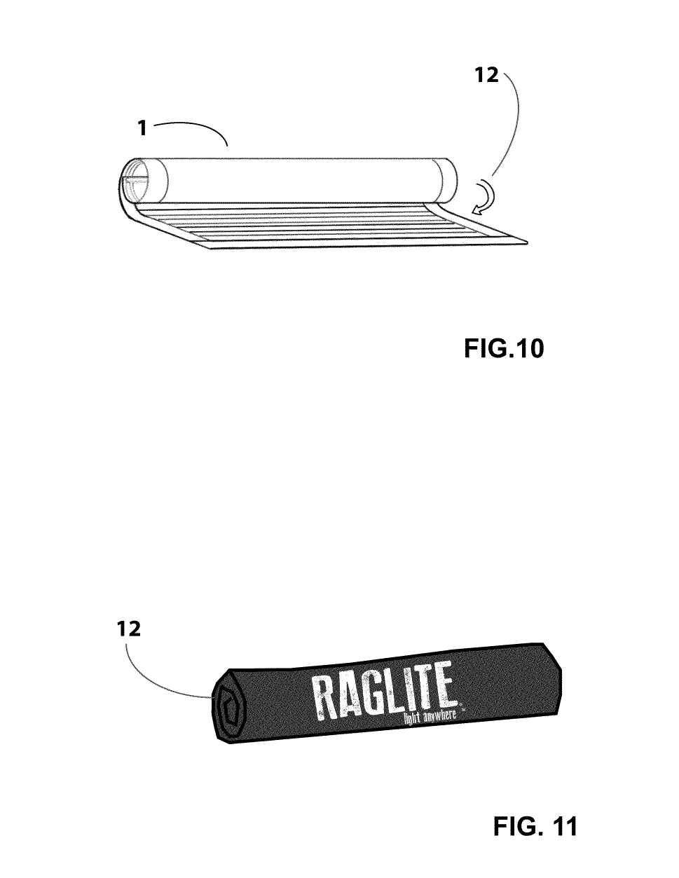

FIG. 10 illustrates an example light bank roll-up 1 consisting of the fabric, Velcro and the array of LED strips can be rolled up to flag off light or for storage 12.

FIG. 11 is an example rolled light bank 1 consisting of the fabric, Velcro and the array of LED strips can be rolled up for storage or transport 12.

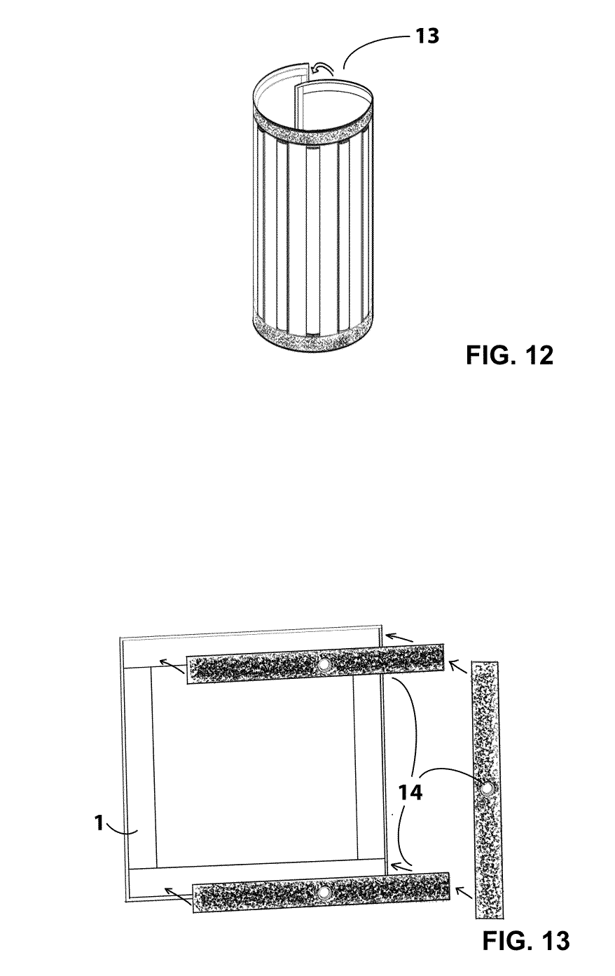

FIG. 12 illustrates a 360 degree torch mode with an example light when Velcro ends are attached 13.

FIG. 13 illustrates an example flexible Velcro frame system that includes a bendable metal strips encase within Velcro where one side is hook and one side is loop 14 can be attached to a light bank 1 to make the fabric more ridged.

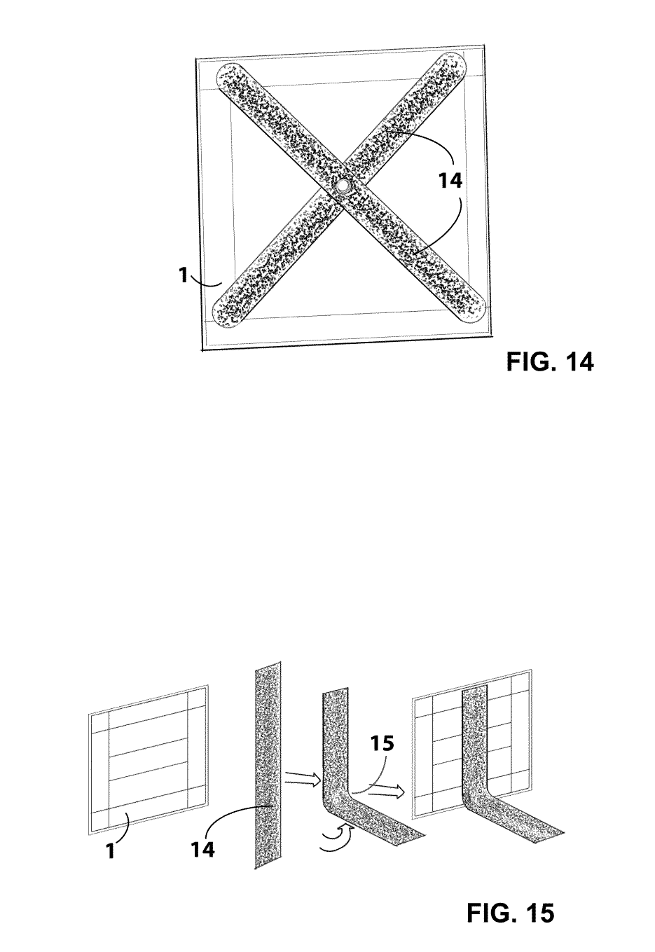

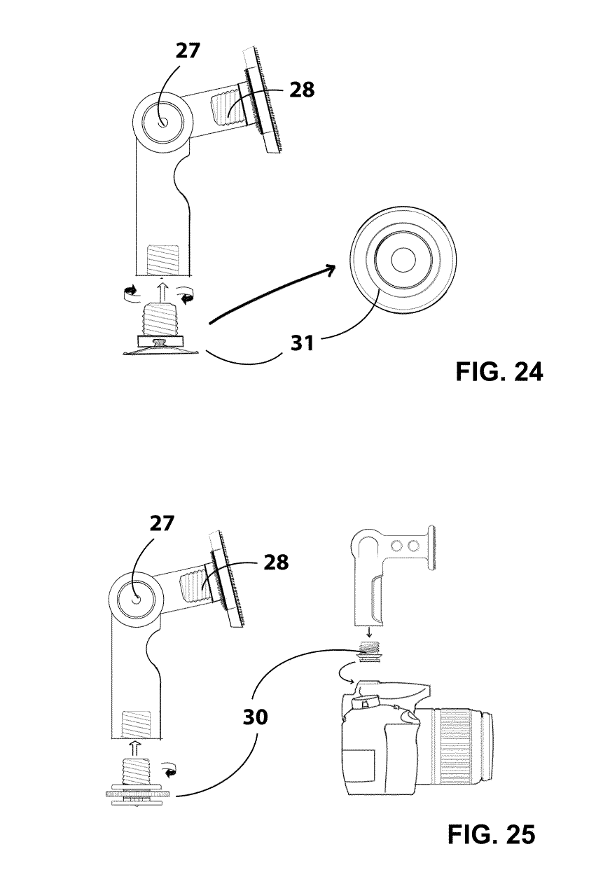

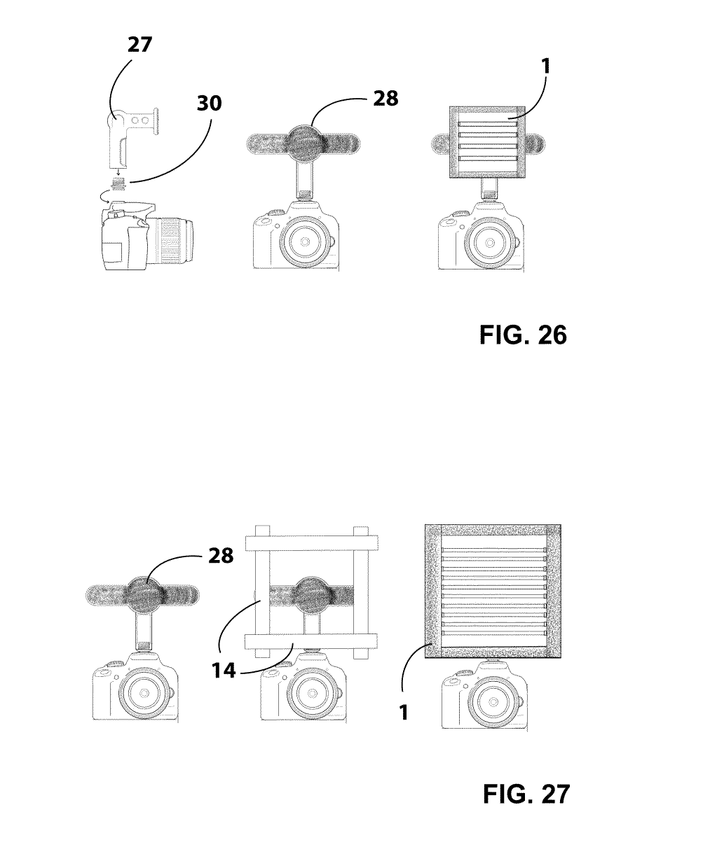

FIG. 14 illustrates an example frame system criss-cross that includes bendable metal strips encased within Velcro where one side is hook and one side is loop 14 can be attached to a light bank 1 to make the fabric more ridged and a hole which allows for studs 15 and various mounts FIG. 23, FIG. 24, FIG. 25 and FIG. 26.

FIG. 15 illustrates an example flexible mounting frame stand with bendable metal 15 strips encased within Velcro where one side is hook and one side is loop 14 can be bent and attached to the front or back of light bank 1 to make it rigid and a stand on its own 15.

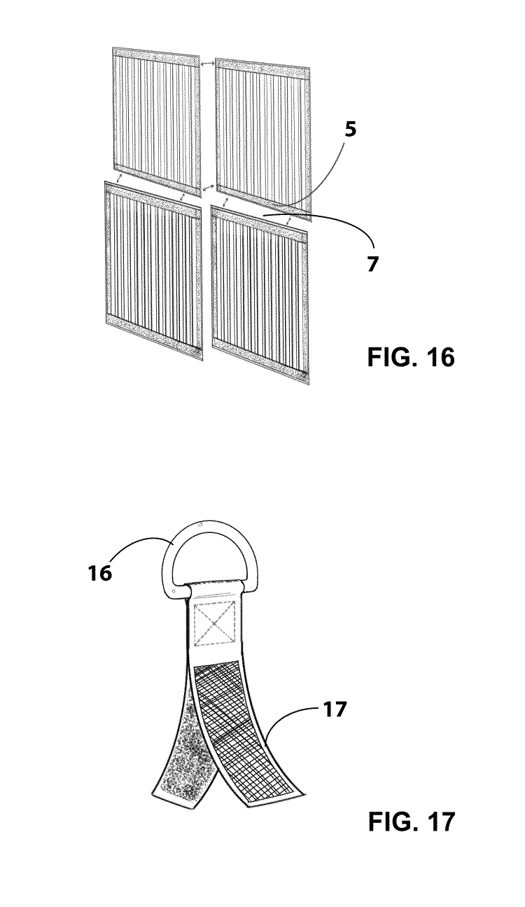

FIG. 16 illustrates an example light bank array, which attaches multiple light banks 1 together to form a larger light source by Velcroing the front hook side 5 of the one light or back loop side 7 to another light bank.

FIG. 17 illustrates example D-ring accessories with a metal D-Ring 16 sewn into fabric with two strips with Velcro on both front loop and back hook 17.

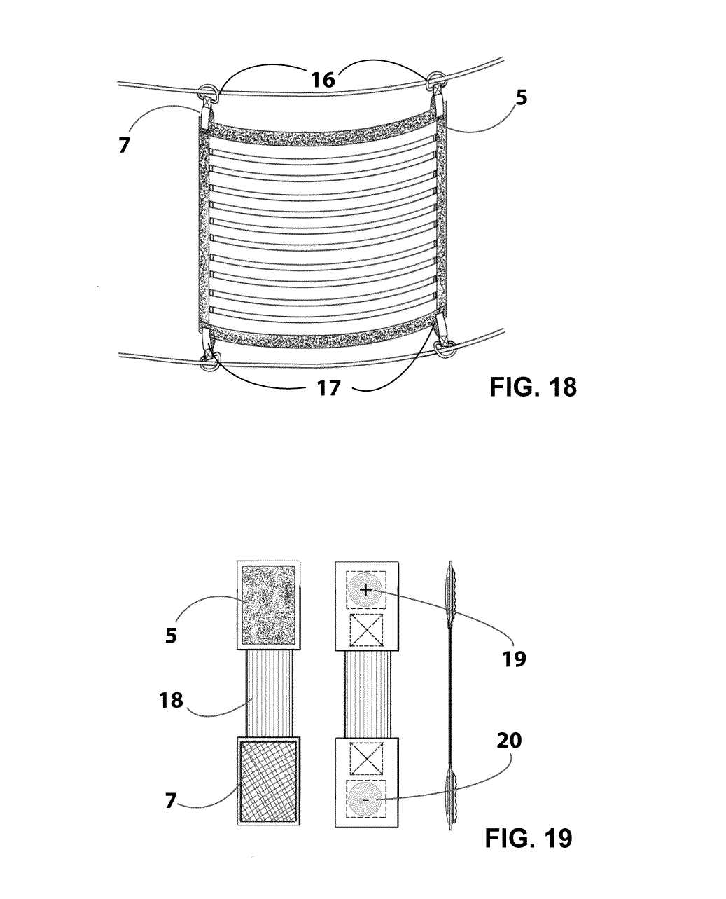

FIG. 18 illustrates example mounting accessories for hanging metal D-Rings 16 sewn into fabric with two strips with Velcro on both front and back 17 to attach the front hook side 5 and back loop side 7 of the light bank 1 to allow the light to be hung or mounted to objects.

FIG. 19 illustrates an example elastic magnetic accessory with a hook side 5 with a positive facing magnet 19 connected with an elastic band 18 to loop side 7 with negative facing magnet 20 to attach to metal surfaces or hold filters and gels.

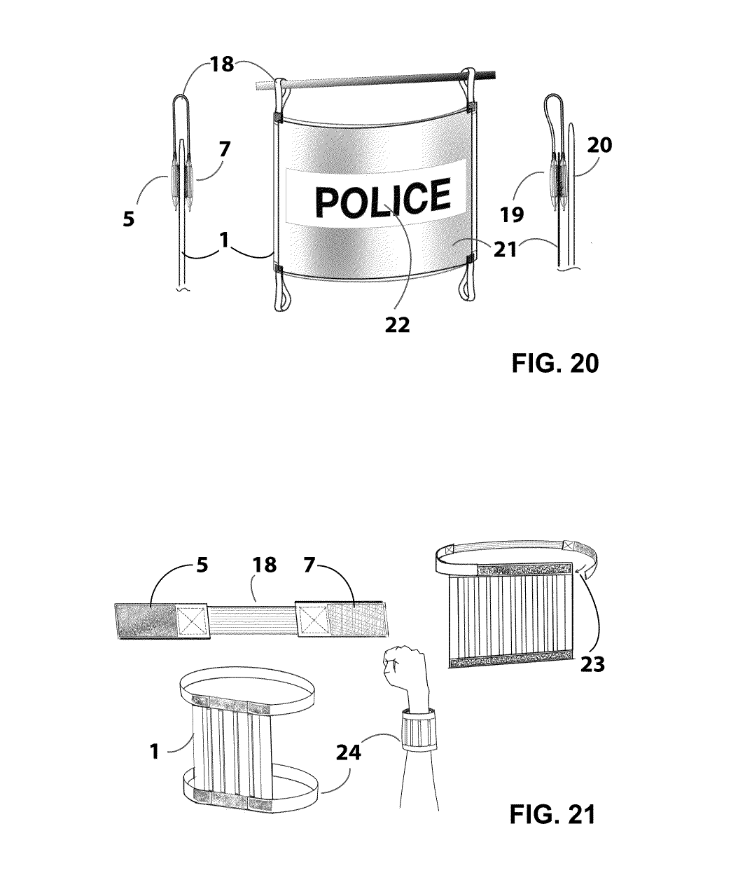

FIG. 20 illustrates an example Velcro magnetic gel holder that attaches to the light bank 1 via a hook side 5 with positive facing magnet 19 connected with an elastic band 18 to loop side 7 with negative facing magnet 20 to attach to metal surfaces or hold filters and gels 21 with artwork or logo 22. The elastic bands 18 can be used to loop around a pole for hanging and mounting to an object.

FIG. 21 illustrates example elastic Velcro straps attached to the light bank 1 via hook side 5 connected with an elastic band 18 to loop side 7 which can be strapped to a body part, such as a hand, arm or leg 24 or around an object like a pole.

FIG. 22 illustrates example adjustable Velcro straps attached to the light bank 1 a strap with hook side on one side 5 and the loop side on the other 7 which can be adjusted with buckles and strapped to a body part, such as the chest or bag 26 or around an object like a pole.

FIG. 23 an example frame mount with a hook Velcroed propeller pad 28 threads into adjustable angle pistol grip 27 and mounts to the back of the light source bank 1.

FIG. 24 an example suction mount with a hook Velcroed propeller pad 28 threads into adjustable angle pistol grip 27 and mounts to a suction cup 31 to attach to various surfaces.

FIG. 25 illustrates an example camera hot shoe mount with a hook Velcroed propeller pad 28 threads into adjustable angle pistol grip 27 and mounts to the hot shoe of a camera 30.

FIG. 26 an example lighted camera mount with a hook Velcroed propeller pad 28 threads into adjustable angle pistol grip 27 and mounts to the hot shoe of a camera 30 and mounts to the back of the light source bank 1.

FIG. 27 illustrates an example camera mount with a frame, a light, and a hook Velcroed propeller pad 28 attaches to bendable metal strips encase within Velcro where one side is hook and one side is 14 can be bent and attached to the front or back of light bank 1.

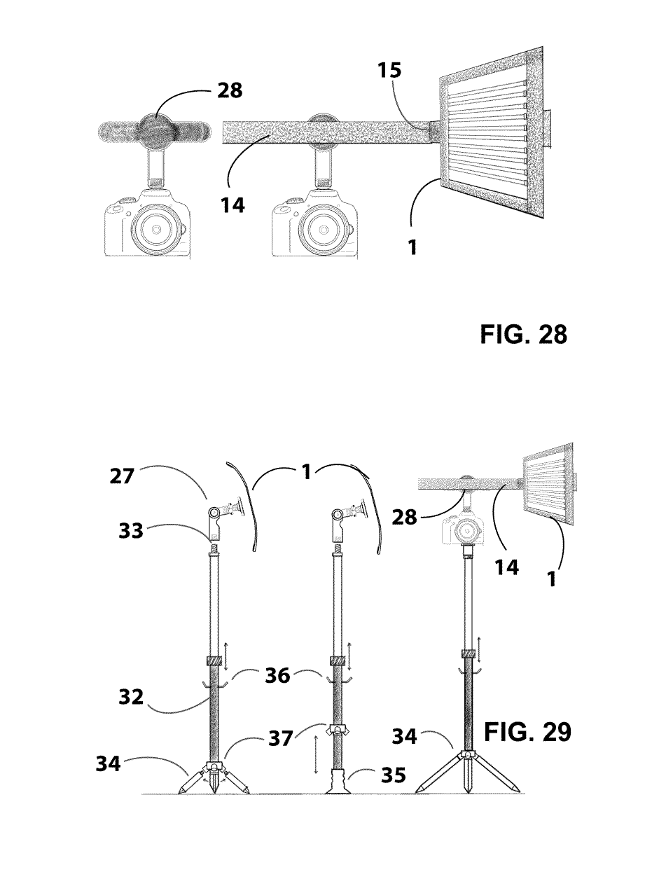

FIG. 28 illustrates an example camera mount with a bendable frame, a light, and a hook Velcroed propeller pad 28 that attaches to bendable metal 15 strips encase within Velcro where one side is hook and one side is loop 14 can be bent and attached to the front or back of light bank 1.

FIG. 29 is an example of a boom pole and light stand with a junction with a forty-five (45) degree 37 which attaches to the loop Velcroed wrapped pole 32 at any position on the pole. Poles form the base of the stand 34. Various attachment can be added for stability such as spikes for yard stand or multiple junction points 37, rubbered shoe for a floor stand 35. Poles can be connected together to form a longer pole or higher stand. A weight can be applied to pegs for added stability 36. Threads male connector 33 a hook Velcro elcroed propeller pad 28 threads into adjustable angle pistol grip 27 attaches to bendable metal 15 strips encase within Velcro where one side is hook and one side is loop 14 can be bent and attached to the front or back of light bank 1.

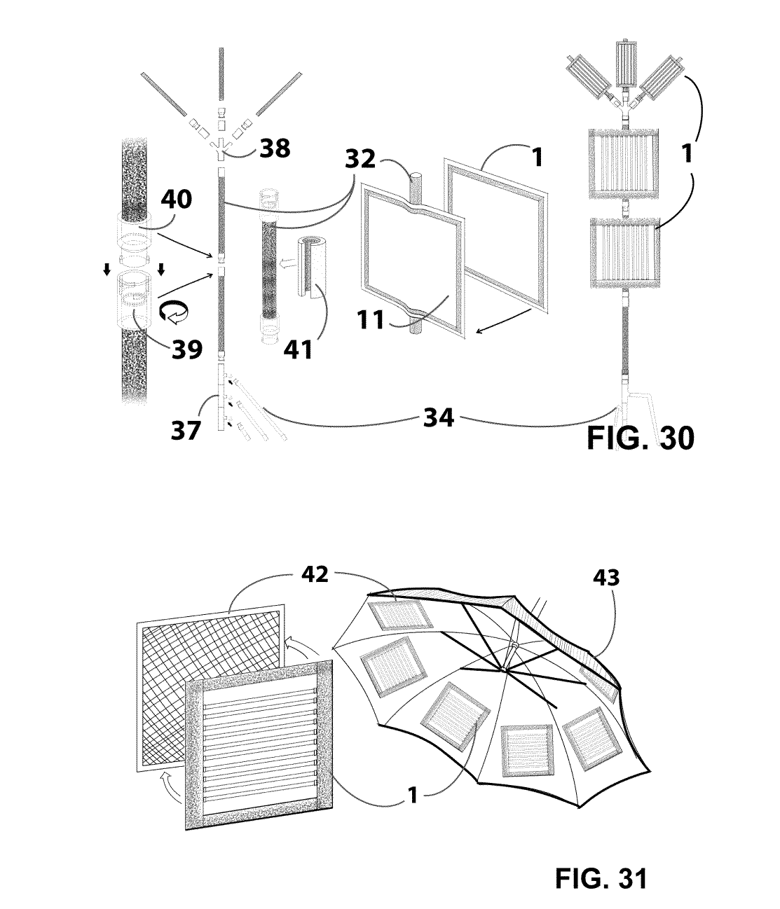

FIG. 30 is an example of a stand with an attachment and a forty-five (45) degree junction 37 which attaches to poles 34 to form the base of the stand. Loop Velcroed wrapped pole 32 with male cap twist locks into a female cap on the other pole to make stands of any height, boom poles of any length and light stands of any size and configuration. Back fabric cover lined with hook Velcro borders 11 allows a light bank 1 to be attached at any position on the pole 32. Various attachment 38 can be added for different configurations, comfort and stability such as spikes for yard stand 34, rubbered shoe for a floor stand 35 or a foam grip attachment with Velcro Velcro hook on the inside attaches to the loop Velcroed wrapped pole 32 to make a comfortable hand grip at any position on the pole.

FIG. 31 is an example of an umbrella light bank with a cloth material umbrella 43 with Velcro hook pads 42 allows a light bank 1 to be attached to make a larger light source.

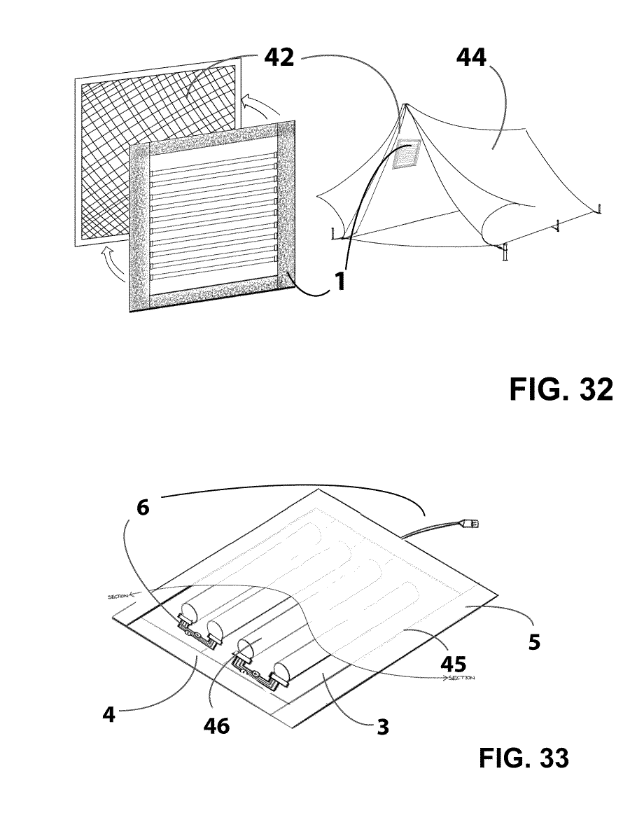

FIG. 32 is an example of a tent attachment with a cloth material for shelter 44 with Velcro hook pads 42 allows a light bank 1 to be attached for interior or exterior illumination.

FIG. 33 is an example of a power source in the form of a battery pack 45 consisting of the outer fabric shell 4 containing an array of battery cells 46 connected through an electrical circuit 6 attached to a flexible material 3 with hook Velcro borders 5.

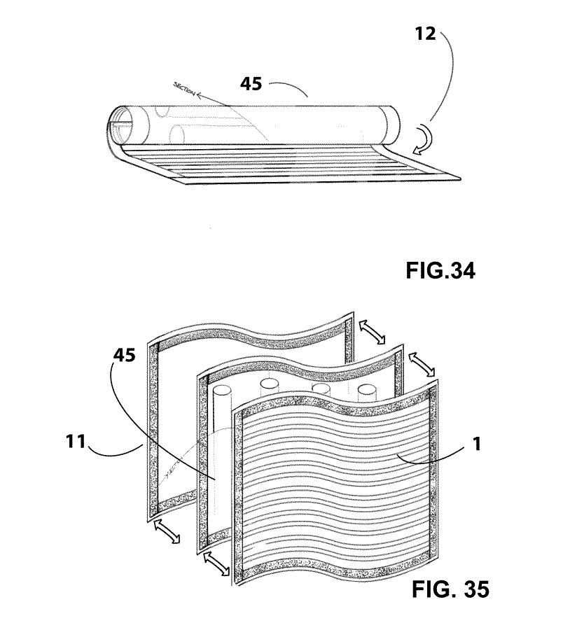

FIG. 34 is an example of a roll-up battery pack 45 consisting of the fabric, Velcro and the an array of battery cells can be rolled up for storage 12.

FIG. 35 is an example view of a fabric cover lined with hook Velcro borders 11 attaches to a battery pack 45 consisting of the outer fabric shell containing an array of battery cells connected through an electrical circuit attached to a flexible material with hook Velcro borders connected to a light bank 1.

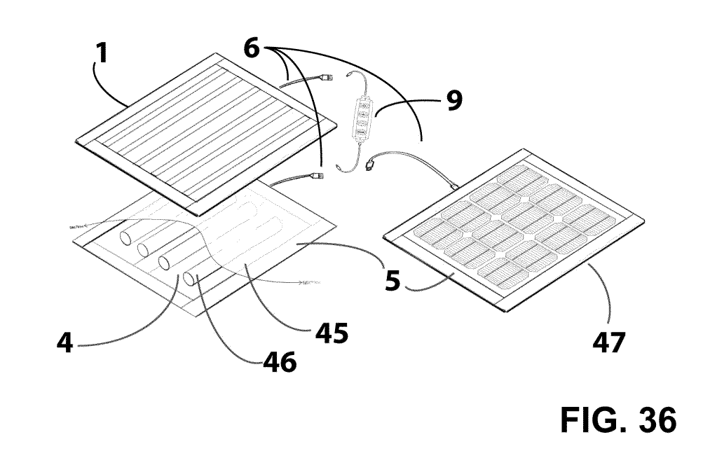

FIG. 36 illustrates an example of a power source and solar charger component in a fabric encased battery housing 45 with hook Velcro borders 5 containing an array of battery cells 46 to power the light bank 1 connected through an electrical circuit 6 to the light controller 9 connected through an electrical circuit 6 into a power supply or a flexible fabric mounted solar array 47 for charging.

While the present invention has been illustrated by a number of preferred embodiments, a person of ordinary skill in the art will readily recognize that deletions, additions, modifications and improvements can be made while remaining within the scope and spirit of the appended claims.

The invention is claimed as follows:

1. A lighting apparatus, comprising:
a flexible surface;
a plurality of light emitting diodes (LEDs) attached to the flexible surface;
a hook and loop mounting system attached to the flexible surface; and
a daisy chain connector for attaching an additional lighting apparatus.

2. The lighting apparatus of claim 1, further comprising a battery back connector.

3. The lighting apparatus of claim 2, further comprising a battery pack connected to the battery back connector.

4. The lighting apparatus of claim 1, further comprising a solar pane connector.

5. The lighting apparatus of claim 4 further comprising a solar panel connected to the solar panel connector.

6. The lighting apparatus of claim 1, further comprising a loop hook and loop borders.

7. The lighting apparatus of claim 1, further comprising a light controller in a waterproof housing.

8. The lighting apparatus of claim 1, further comprising a waterproof cable.

9. The lighting apparatus of claim 1, further comprising a carrying pocket.

10. The lighting apparatus of claim 1, further comprising a bendable metal strips.

11. The lighting apparatus of claim 1, further comprising a frame system criss-cross.

12. The lighting apparatus of claim 1, further comprising a D-ring.

13. The lighting apparatus of claim 1, further comprising a magnetic accessory with a hook side.

14. The lighting apparatus of claim 1, further comprising a hook and loop magnetic gel holder.

15. The lighting apparatus of claim 1, further comprising a adjustable hook and loop straps.

16. The lighting apparatus of claim 1, further comprising a suction mount with a hook and loop propeller pad.

17. The lighting apparatus of claim 1, further comprising a lighted camera mount with a hook and loop propeller pad.

18. The lighting apparatus of claim 1, further comprising a a boom pole and light stand.

19. The lighting apparatus of claim 1, further comprising a umbrella light bank with a cloth material umbrella.

20. The lighting apparatus of claim 1, further comprising a tent attachment.
